(19) United States
(12) Patent Application Publication
(10) Pub. No.: US 2015/0182395 A1
(43) Pub. Date: Jul. 2, 2015

(54) MANUAL WHEELCHAIR WHEEL HANDLING DEVICE FOR THE HANDICAPPED

(71) Applicant: Commissariat à l'énergie atomique et aux énergies alternatives, Paris (FR)

(72) Inventor: Roland Pelisson, la Terrasse (FR)

(21) Appl. No.: 14/576,923

(22) Filed: Dec. 19, 2014

(30) Foreign Application Priority Data
Dec. 26, 2013 (FR) 13 63599

(51) Int. Cl. A61G 5/10

(52) U.S. Cl. CPC A61G 5/10

(57) ABSTRACT

Device for handling a wheel of a manual wheelchair, comprising a lever support having a gripping part, installed free to rotate on the wheel, an attachment means for attaching the lever support capable of putting the lever support into position free to rotate about the rotation axis of the wheel, a pusher strut installed free to rotate relative to the lever support, the attachment zone of the pusher strut on the lever support being chosen so a force applied to cause rotation of the lever support in its first direction of rotation creates contact between the pusher strut and the handrim and moves the manual wheelchair forwards, and such that a force applied to cause rotation of the lever support in its second direction of rotation creates a lack of contact or a slipping contact between the handrim and the pusher strut and puts the device into its disengaged position.

### TECHNICAL FIELD

This invention relates to the field of personal transport wheelchairs specially adapted for handicapped persons, and more particularly to the field of wheelchairs propulsed by the handicapped person, also called manual wheelchairs.

The invention thus discloses a device for handling a manual wheelchair wheel for a handicapped person, a wheel of a manual wheelchair and a manual wheelchair comprising such a device, and a method for operation of this handling device.

### STATE OF PRIOR ART

A significant proportion of the world's population is daily concerned by the use of wheelchairs for handicapped persons in order to be able to move around.

Among these, wheelchairs with no power assistance for displacement called manual wheelchairs rely on action by the handicapped person using his or her arms to turn a hoop fixed on the outside of the wheel (one for each wheel), this hoop usually being called a “handrim”.

The handrim is in the form of a tube with a circular or flattened cross-section, and enables good gripping by the user's hand and transformation of arm movements into a rotation of the wheel. This wheel rotation enables the handicapped person to move forwards or backwards or to pivot his wheelchair. The user can apply the brake to the wheelchair by squeezing the handrim, without moving his or her arms.

Existing manual wheelchairs are lightweight and simple in design. Furthermore, the principle of propulsion of the wheelchair using the handrim makes the wheelchair very easy to handle on smooth horizontal ground. This innovation restores some independence to handicapped persons.

Nevertheless, the principle of using the handrim has several disadvantages.

Firstly and principally, one of these many disadvantages is related to the position itself of the handrim, which is very close to the hub of the wheel, the diameter of the handrim necessarily being smaller than the wheel (in other words the tire of the wheel) so that it does not touch the ground. The propulsion torque transmitted to the arm is thus directly related to this difference between the diameter of the tire of the wheel and the diameter of the handrim, typically with a ratio of 60 cm to 50 cm. Thus, the slightest difference in ground level or even minor obstacles can quickly bring the user towards his or her physical limits, in other words it will become impossible to move forwards, at least without becoming tired and starting to feel muscular pain. Therefore there is a high risk of subsequently developing joint problems and the user's displacements will become more restricted with increasing age.

Moreover, due to its inherent design, the handrim usually requires direct contact between the user's hand and the tube of the handrim. The result is then generally a feeling of cold, for example in winter, or a feeling of heat, for example during continuous braking down a long slope, that are unpleasant and potentially painful for the handicapped person, even though they can be slightly attenuated for example by wearing protective gloves. Furthermore, this direct contact between the handrim and the user's hand can be hygienically problematic, for example due to the presence of dirt or microbes on the handrim.

Furthermore, in the special case of braking of the wheelchair in which rotation of the handrim has to be prevented by tightening this handrim, the handicapped person's hand may not be physically strong enough to achieve braking, particularly because physical capabilities reduce with age and handicap.

Solutions have already been disclosed in prior art in order to at least partly limit the effects of these disadvantages. Thus, lever systems on the handrim have been disclosed in an attempt to find a solution mainly to the problem of reducing the propulsion force to be applied by the handicapped person. The thrust force that the user has to generate is then either directly reduced by the “lever length/handrim radius” ratio, or is also modified by the presence of gear type demultiplication means.

For example, international application WO 2008/047088 A2 discloses a lever system for a wheelchair, marketed under the name “NuDrive”, based on a reduction in the propulsion force as a function of the ratio of the length between the lever and the handrim. While this “NuDrive” lever system discloses an attachment of the lever support on the handrim, another system marketed under the name “Wijit” discloses an attachment of the lever support directly onto the hub of the wheel. International patent application WO 2009/025815 A1 also describes another lever system marketed under the name “Pivot” based on a reduction of the propulsion force as a function of the ratio of the lengths of the lever and the handrim, but that also includes a possibility of choosing between five gears through the presence of five different gear ratios in order to step down the movement. It should also be noted that patent application US 2013/0062857 A1 discloses a simplified lever system marketed particularly for the third world, based on the principle of a bicycle wheel with a chain and gear system that enables hand movements at a height on the tubes of the two levers to prefer speed on flat ground and torque when climbing hills and on rough ground.

However, these solutions according to prior art are not fully satisfactory. “NuDrive”, “Wijit” and “Pivot” type lever systems are too expensive and too large. Furthermore, the addition of weight on each wheel imposed by these systems is another difficulty. Furthermore, the lever system in US patent application US 2013/0062857 A1 has a serious limitation because it is not easily operable. It uses bicycle type free wheels such that the lever has to be released when braking (to grip the handrim), and particularly the levers have to be removed to be able to maneuver within a compact area (in particular, it is impossible to push backwards).

In addition to these different lever systems mentioned above available on the market, there are also various solutions disclosed in the literature for prior art designed to satisfy the same need to reduce the thrust force applied by the handicapped person. Focusing on solutions aimed at combining lightweight and compactness, it is worth mentioning patent application JP 2012-223551 A that discloses a lever system attached to the spindle of the wheel and hinged below the handrim, patent application US 2002/0043781 A1 that discloses a fairly similar lever system in which a pad is pressed onto the handrim at each swing of the assembly composed of the grip, the handle and the pad, patent application U.S. Pat. No. 3,877,725 A that uses a similar principle but a more complex assembly, and patent application US 2005/0275190 A1 that also discloses this principle but with an attachment by a slipping connection around the handrim.

Furthermore, unlike these documents in which the top part of the lever swings to start movement of the manual wheelchair, patent application EP 0 728 095 A1 discloses the principle of a roller pressing on the tire of the wheel when the top part of the lever is pushed, the top part of the lever not being hinged. This roller is designed to pivot and to automatically grip on the tire during each push. Prior patent U.S. Pat. No. 3,869,146 A is very similar to it and also discloses the presence of a lateral pad to apply the brake or to slow maneuvers. Patent application EP 1 966 036 A2 consists solely of applying this lateral braking to generate movement. Patent application US 2011/0187075 A1 does not disclose automatic gripping when pushing and discloses squeezing of a brake handle by the user to apply jaws around the rim. Finally, patent U.S. Pat. No. 5,988,661 A discloses the same principle but around the handrim and by lateral pivoting of the handle.

Nevertheless, none of these solutions disclosed in prior art are incapable of providing a satisfactory solution to the expectations of handicapped persons using manual wheelchairs.

### PRESENTATION OF THE INVENTION

There is thus a need to propose an alternative solution to the problem of reducing the propulsion force applied by the handicapped person on the handrim of a wheel of a wheelchair.

There is also a need to design a propulsion aid system that is lightweight, intuitive, removable and compact, otherwise there is a risk that its intrinsic interest will be reduced.

Preferably, such a system should not require any major modification to the wheelchair, so that the global visual aspect of the wheelchair remains unchanged.

There is also a need to disclose such a system to aid operation of a wheelchair allowing the handicapped person to move around on any type of ground, for example dirty ground with wet gravel, earth, sand or grass, even if one or both of the wheels of the wheelchair are damaged, for example in the case of a warped wheel or a twisted handrim.

There is also a need to reduce manufacturing and marketing costs of propulsion aid systems adaptable on manual wheelchairs.

Thus, the purpose of the invention is to at least partially correct the needs mentioned above and the disadvantages related to embodiments according to prior art.

According to one of its aspects, the purpose of the invention is thus a device for handling the wheel of a manual wheelchair for a handicapped person, said wheel comprising a coaxial handrim to enable propulsion of the wheelchair, the device being capable of changing from a disengaged position in which the wheel rotates freely about its rotation axis, to an engaged position in which the wheel is driven in rotation about its rotation axis by the device, characterized in that it comprises:
a lever support configured to be installed in rotation about the rotation axis of the wheel, comprising a gripping part for the handicapped person extending outwards from the handrim when the device is placed on the wheel, said lever support comprising a first part extending inwards from the handrim, between the rotation axis of the wheel and said handrim when the device is in position on the wheel,
a lever support attachment means, capable of putting the lever support into position free to rotate about the rotation axis of the wheel,
a pusher strut fixed on the lever support at said first part, while being mounted free to rotate relative to the lever support about a rotation axis, the pusher strut extending between the lever support and a contact point, the contact point being configured to come into contact with the handrim when the pusher strut rotates about the rotation axis, the lever support being capable of rotating about the rotation axis of the wheel in a first direction of rotation tending to move the lever support closer to the contact point of the pusher strut, and in a second direction of rotation opposite the first direction of rotation,

Advantageously, the attachment zone of the pusher strut on the lever support is chosen on said first part of the lever support such that when the device is in position on the wheel, a force applied on the gripping part to make the lever support rotate about its first direction of rotation causes contact between the distal end of the pusher strut and the handrim, which blocks rotation of the lever support in the first direction of rotation by binding and puts the device in its engaged position, thus causing propulsion of the manual wheelchair, such that a force applied on the gripping part to cause rotation of the lever support in its second direction of rotation cancels the contact or creates slipping contact between the handrim and the pusher strut, which allows free rotation of the lever support in the second direction of rotation and thus puts the device in its disengaged position.

The attachment means of the lever support that allows the lever support to be put into place free to rotate about the rotation axis of the wheel, may for example be fixed on the rotation axis of the wheel, or even better on the hub or one or several spokes of the wheel.

The first direction of rotation of the lever support tends to move the lever support towards the contact point of the pusher strut. In other words, in its first direction of rotation, the lever support moves towards the pusher strut. In other words, the first direction of rotation of the lever support tends to reinforce the pressure between the pusher strut contact point and the handrim, such that the pusher strut binds on the handrim.

With the invention, a handicapped person dependent on a wheelchair to move around, can use his (or her) wheelchair more easily with more intuitive handling while minimizing physical forces to be generated. In particular, the device can be easily adapted onto an existing wheelchair, and it can provide the handicapped person with additional aid in movements in order to reduce risks of the development of joint problems, particularly in the arms and/or shoulders. Furthermore, unlike solutions according to prior art, the actuation principle of the lever in the device according to the invention can enable the device to slip relative to the handrim, which facilitates the reduction in the propulsion force applied by the handicapped person while making it possible to design a lightweight device. Furthermore, since such a device is not necessarily used all the time, it can easily be seen as a practical low cost accessory that can be fixed onto the wheelchair when the situation requires too much physical force using handrims alone or in order to protect joints and muscles. The invention can also enable assembly and disassembly of the device on a manual wheelchair without having to assemble and disassemble the wheels of the wheelchair.

The handling device according to the invention may also comprise one or several of the following characteristics taken in isolation or in any technically possible combination.

Advantageously, the device according to the invention has a low total weight, particularly less than or equal to about 300 g, even better less than or equal to about 200 g.

The device can advantageously be configured so that it can be installed on and removed from the manual wheelchair, particularly on a wheel of the manual wheelchair. In this way, the handicapped person may for example transport the device and use it as necessary, particularly when the wheelchair as to be moved on ground that requires too much physical force to move when the handrim alone is used.

Conventionally, the handrim of the wheel may be in the form of a tube with a circular or flattened cross-section extending around the entire periphery of the wheel. Thus, the handrim and the wheel advantageously have the same axis of rotation.

The lever support may be generally longitudinal in shape, particularly straight, from the center of rotation of the wheel of the wheelchair towards the distal end of the gripping part of the lever support.

The lever support may be fixed to the rotation axis of the wheel at its proximal end opposite its distal end that may be coincident with the distal end of the gripping part.

The lever support is advantageously longer than the radius of the handrim, such that the lever support may have a gripping part extending outwards from the handrim.

The lever support may be designed to be telescopic so that it can increase or reduce the distance between the gripping part and the rotation axis of the wheel as a function of the intensity of the physical force that the handicapped person would like to apply to actuate the lever support.

The different parts of the device according to the invention, and particularly the lever support and/or the pusher strut, may be made from any type of material, for example metal, plastic, carbon fibers or even wood. This choice may depend on the required stiffness, weight and cost characteristics and the feasibility of the device according to the invention.

The pusher strut advantageously comes into contact with the handrim at its internal surface, in other words oriented towards the rotation axis of the handrim. In this way, unlike a contact made at the external surface opposite the internal surface of the handrim, or even on the tire of the wheel, it might be possible to avoid difficulties with contact feasibility, for example such as the development of unwanted slipping, when the external surface of the handrim or the tire are dirty, for example due to traveling on greasy ground or even when the tire is underinflated or overinflated.

The pusher strut may be approximately longitudinal in shape, and particularly straight from the attachment zone to the lever support towards the distal end of the pusher strut that can come into contact with the handrim.

The pusher strut may be fixed to the lever support at the attachment zone through its proximal end.

The length of the pusher strut is advantageously less than or equal to the diameter of the handrim, particularly less than or equal to the radius of the handrim, such that it can come into contact with the handrim while being fixed on the part of the lever support extending inwards from the handrim.

The sum of the length of the pusher strut and the length of the lever support between the rotation axis of the wheel and the attachment zone of the pusher strut may be greater than or equal to the radius of the handrim.

Preferably, the attachment zone of the pusher strut to the lever support may be located in the upper third of the part of the lever support extending inwards from the handrim, in other words between the handrim and two thirds of the length of the lever support measured from the rotation axis of the wheel.

A friction contact cone can also be defined between the pusher strut and the handrim, with the vertex at said contact and with half-angle at the vertex equal to the angle of friction defined by the relation μ=tan φ, where μ is the adhesion coefficient between the pusher strut and the handrim. The attachment zone of the pusher strut on the lever support may be located inside the friction cone.

In this way and advantageously, slipping between the pusher strut and the handrim cannot take place regardless of the force applied by the handicapped person on the gripping part of the lever support to cause rotation of the lever support in its first direction of rotation towards the pusher strut, the pusher strut being blocked in contact with the handrim by a binding effect.

This principle of a non-slip condition between the pusher strut and the handrim dependent on the angle of friction is derived directly from Coulomb's laws in terms of adhesion between two solids, well known in the literature.

The device may also comprise an extension handle of the pusher strut, extending mostly outwards from the handrim when the device is in position on the wheel, so that the handicapped person can turn the pusher strut about its axis of rotation.

Advantageously, the extension handle of the pusher strut may be coincident with a braking handle of the device according to the invention. A force applied on this brake handle to cause rotation of the pusher strut towards the lever support can generate a blocking contact by binding of the pusher strut on the handrim with the effect of braking or even stopping rotation of the handrim and therefore the wheel. In other words, squeezing or moving the brake handle towards the lever support can cause braking of the wheel, in the same way as the brake handle of a bicycle. Conversely, a force applied on this brake handle to cause rotation of the pusher strut in the direction away from the lever support can release or disengage the device causing free rotation of the lever support about the rotation axis of the handrim.

The device may also comprise an elastic return device fixed between the lever support and the pusher strut.

For example, the elastic return device may consist of a spring or an elastic.

The elastic return device may for example be fixed to the pusher strut, at or close to the distal end of the pusher strut. Similarly, the elastic return device may for example be fixed to the lever support, at or close to the distal end of the part of the lever support extending inwards from the handrim.

The elastic return device can advantageously have an initial tension, in other words when it is not being stretched, so that the pusher strut can be moved towards the lever support to maintain permanent contact of the pusher strut on the handrim, particularly even if the handrim becomes oval, for example as a result of defects and/or shocks applied to it.

Furthermore, the elastic return device may have a maximum extension at which the pusher strut is moved away from the handrim, for example to release a brake lining fixed on the pusher strut from the handrim, particularly a surrounding brake lining to at least partially match the shape of the handrim tube so that among other possibilities, the device can be disassembled from the wheel.

The device may also comprise a device to lock the pusher strut in the position at a distance from the handrim so as to make sure that there is no contact between the pusher strut and the handrim, the locking device extending between the pusher strut and the lever support, and being fixed to the pusher strut or to the lever support.

In this way, it may be possible to permanently disengage the lever support when the locking device is correctly positioned between the lever support and the pusher strut. The handicapped person can then decide to move forwards in the conventional manner making use of the handrim without using the device.

However, the locking device may be elastic and it may have sufficient elasticity to enable the pusher strut and the lever support to be moved towards each other making use of the brake handle, for example to make it possible to handle the wheelchair in a restricted space using the brake handle and the gripping part. To achieve this, it may then be sufficient if the force applied by the locking device between the pusher strut and the lever support compensates for the tension in the elastic return device to achieve the permanent disengagement function, while enabling some deformation of the locking device when the brake handle is activated until contact can be set up between the handrim and the pusher strut. Alternately, the elastic return device and the locking device can be replaced by a single part that performs their two functions by itself.

The device may also comprise an attachment means for connecting the lever support to the frame of the manual wheelchair, extending between the lever support and the frame of the manual wheelchair, the attachment means enabling support of the lever support if the device is disengaged and/or aid in pushing the lever support after the handicapped person has pulled on the lever support.

In particular, the attachment means may be connected to the front frame of the manual wheelchair, for example located in the area in which the legs of the handicapped person are located. The attachment means may for example be attached to the frame of the manual wheelchair after the lever support has been put into position on the wheel.

The attachment means may be fixed to the lever support at the distal end of the lever support, particularly coincident with the distal end of the gripping part. As a variant, the attachment means may be designed to slide inside the lever support and if possible fixed to or close to the rotation axis of the wheel, so as to enable greater amplitude and greater flexibility.

The attachment means may preferably be elastic, particularly extendable by a factor of more than two or even three relative to its initial length, in other words its length when there is no elongation. For example, the attachment means may be a tensioner or a winding system.

When the attachment means is designed to be sufficiently flexible, it can act as a support for the lever support when the lever support is not used, in other words particularly when the device is disengaged.

Furthermore, when the attachment means is designed to be sufficiently rigid or when it is associated with another more rigid attachment means, for example with a pulling force of between 5 and 10 kg when actuation of the lever support causes elongation of the attachment means, the pulling force of the lever support causing stretching of the attachment means can provide a reserve of potential energy for the thrust force on the lever support. In other words, the tension in the attachment means that increases when it is pulled, can help the handicapped person when the person pushes on the lever support towards the attachment point of the attachment means onto the frame of the wheelchair since the elastic return of the attachment means facilitates this pushing force. This additional aid provided to the handicapped person to apply the thrust force may be particularly useful when the wheelchair moves on difficult ground, for example sloping ground, ground covered with grass, gravel, or other types of ground because the wheelchair may tend to stop moving between two pushes.

The gripping part of the lever support may comprise a pivoting handle, installed to rotate about the lever support, and a connection rod support fixed to the pivoting handle at a first of its ends, and to the pusher strut at a second of its ends opposite the first end, such that rotation of the pivoting handle in a first direction causes the handrim and the pusher strut to move towards each other, and rotation of the pivoting handle in a second direction opposite the first direction moves the pusher strut and the handrim away from each other.

The connecting rod support can thus provide a connection between the pivoting handle and the pusher strut, each rotation of the pivoting handle making it possible to lock or to break the contact between the pusher strut and the handrim. Rotation of the pivoting handle can thus replace use of the previously disclosed brake handle.

The connecting rod support may also comprise an opening at its second end fixed to the pusher strut, inside which an attachment pad of the pusher strut can slide. In this way, it may be possible to enable an unloaded travel distance of the pivoting handle between the engaged and disengaged states of the device so as to maintain self-tightening or the binding effect between the pusher strut and the handrim when the locking device allows free rotation of the pusher strut.

The pusher strut may also comprise a brake lining support that can come into contact with the handrim.

The brake lining support, also called the brake pad support, may in particular be located on the distal end of the pusher strut.

The brake lining support may have a surrounding shape to match the profile of the handrim. In particular, the brake lining support may have a “dish” shaped cross-section. The brake lining support may have a surrounding shape designed to prevent any friction between the brake lining support and the attachment cleats of the handrim on the wheel.

The braking lining support may have a contact point or a contact area with the handrim.

The brake lining support may be made from any type of material, for example like a bicycle brake lining.

The material of the brake lining support may be chosen as a function of the material of the handrim in order to obtain a coefficient of adhesion between the brake lining support and the handrim that will result in an angle of friction adapted to the choice of the position of the attachment zone between the lever support and the pusher strut.

The attachment means for connecting the lever support to the rotation axis of the wheel may also comprise a threaded part capable of engaging on the rotation axis of the wheel when the device is assembled so that it can be permanently fixed to it, the lever support then being installed in rotation on the threaded part.

Advantageously, the threaded part is positioned on the original rotation axis of the wheel of the manual wheelchair, also called the fast disassembly axis of the wheel, in replacement of the original adjustment nut of the wheel.

The threaded part may comprise a pusher element extending the original pusher of the wheel, such that the wheel can be removed even if the device according to the invention is placed on the wheel.

The threaded part may also comprise one or several recesses, for example grooves or holes, and particularly two diametrically opposite recesses so that a wheel locking means can be installed when the device according to the invention has been installed. For example, locking may consist of a pin or a more sophisticated locking system.

Advantageously, the threaded part used to assemble the device according to the invention onto the wheel of the manual wheelchair can be permanently left in position on the rotation axis of the wheel, even if the device according to the invention is removed, without modifying the global aesthetic appearance of the wheelchair.

The length of the threaded part may advantageously be chosen to enable elongation of the fast disassembly axis of the wheel so that the lever support can be put into position on this axis. Thus, for example, the length of the threaded part may be of the order of 1 to 3 cm.

The attachment means may also comprise an attachment ring support, inside which the threaded part can slide, such that the attachment ring support is mounted in rotation relative to the threaded part. The lever support can then be fixed to the attachment ring support so that it can be driven in rotation about the threaded part.

The attachment ring support may comprise an external thread and two nuts that will be positioned on each side of the lever support, to allow adjustment of the c/c distance of the lever support depending on the type of wheel used, the offset of the hub relative to the handrim not being standardized on manual wheelchairs.

The device may also comprise an electrical movement assistance module in the form of a motor-driven rotating roller that will be brought into contact with the handrim, rotation of the roller causing rotation of the handrim.

The electrical assistance module may be lightweight. For example, it may be in the form of a Solex® type motor driven roller.

The electrical assistance module may be used with or in replacement of the brake lining support of the pusher strut.

For example, the electrical assistance module may have operating endurance of at least 3 minutes, or even better 5 minutes, for example between 5 and 10 minutes. In this way, the handicapped person may use this electrical assistance module if necessary to replace the handrim and/or the handling device so as to be able to move around, particularly when the wheelchair is located on ground with several obstacles.

Also advantageously, the electrical assistance module may be designed to remain discrete and located on a reduced portion of the wheel, so as not to create an hindrance for the handicapped person.

The return torque from the electrical assistance module may be resisted by an attachment means, particularly a tensioner type means like that disclosed above, fixed to the frame of the manual wheelchair.

Another purpose of the invention according to another of its aspects is a wheel of a manual wheelchair for a handicapped person characterized in that it is fitted with a handling device like that defined previously.

Another purpose of the invention according to another of its aspects is a manual wheelchair for a handicapped person, characterized in that it comprises a handling device as defined above or a wheel as defined above.

Another purpose of the invention according to another of its aspects, is an operability method for a handling device as defined previously in which the handicapped person performs one or several of the following actions:
the handicapped person pushes the gripping part of the lever support in a first direction of rotation of the lever support, so as to make the manual wheelchair move forwards,
the handicapped person pulls the gripping part of the lever support in a second direction of rotation of the lever support in order to disengage the device so as to bring the lever support backwards before pushing the gripping support again to move the manual wheelchair forwards once again,
the handicapped person moves the pusher strut towards the lever support to create contact between them in order to apply a brake to the manual wheelchair,
the handicapped person moves the pusher strut towards the lever support to create contact between them by binding and pulls the assembly formed by the pusher strut and the lever support in order to move the manual wheelchair backwards.

Another purpose of the invention according to another of its aspects, is an electrical assistance module for displacement of a wheel of a manual wheelchair for a handicapped person, characterized in that it is in the form of a rotating motor-driven roller put into contact with the handrim of the wheel, rotation of the roller causing rotation of the handrim.

The operability process and the electrical assistance module according to the invention may include any of the previously mentioned characteristics, taken in isolation or in any technically possible combination with other characteristics.

### BRIEF DESCRIPTION OF THE DRAWINGS

The invention may be better understood after reading the detailed description given below of a non-limitative example embodiment of the invention, and an examination of the diagrammatic and partial figures in the appended drawing in which:

FIG. 1 shows a simplified perspective view of an example embodiment of a handling device according to the invention,

FIG. 2 shows the operating principles of the device shown in FIG. 1,

FIGS. 3 to 7 show simplified perspective views of variant embodiments of the device shown in FIG. 1,

FIG. 8 shows a simplified perspective view of a manual wheelchair and a wheel comprising a variant embodiment of the device shown in FIG. 1,

FIG. 9 is an enlarged view of FIG. 8,

FIG. 10 shows a perspective view of the principle for assembling the device according to the invention on the rotation axis of a wheel of a manual wheelchair, and

FIGS. 11A to 11D show steps in an operability process of two devices according to the invention, installed on the two wheels of a manual wheelchair.

In all of these figures, identical references may denote identical or similar elements.

Furthermore, the different parts shown in the figures are not necessarily all at the same scale, to make the figures more easily readable.

### DETAILED PRESENTATION OF A PARTICULAR EMBODIMENT

Throughout this description, the terms “proximal” and “distal” should be understood with respect to the X rotation axis of the wheel 10, the term “proximal” referring to the portion closest to the X rotation axis and the term “distal” referring to the portion furthest from the X rotation axis. Thus, a proximal end of an element is the portion closer to the X rotation axis of the wheel 10 than its distal end that is opposite to it. The terms “inner” and “outer” are also used with reference to a radial direction, in other words a direction perpendicular to the X rotation axis of the wheel 10, such that for example a first element extending inwards from a second element is closer to the X rotation axis of the wheel 10 than the second element. Similarly, a first element extending outwards from a second element is further from the X rotation axis of the wheel 10 than the second element.

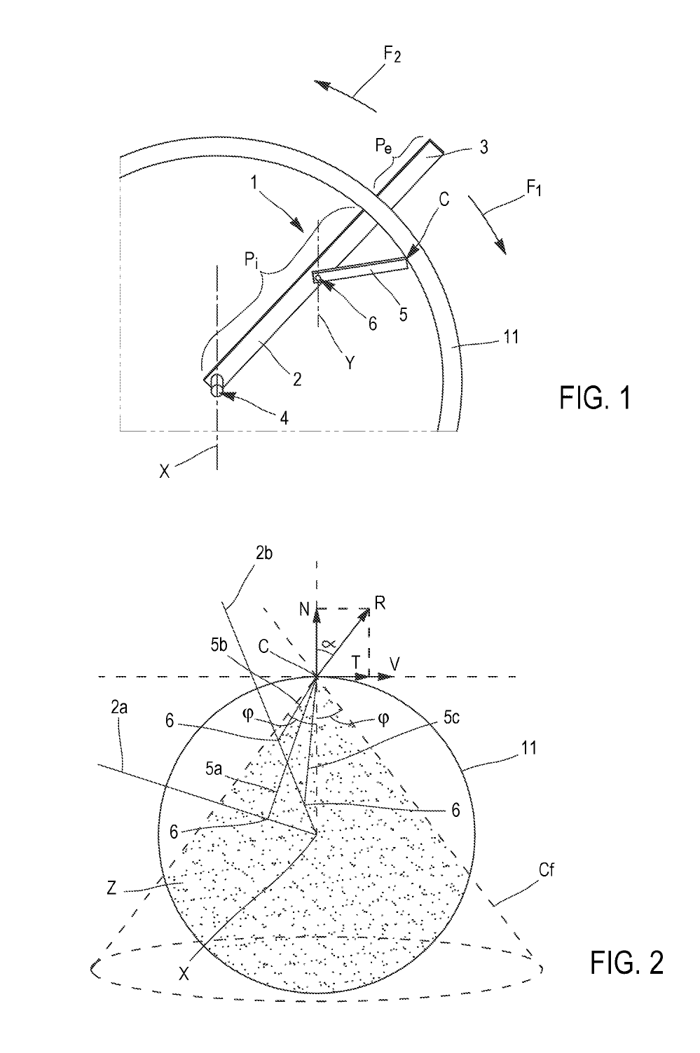

An example embodiment of a handling device 1 according to the invention for manipulating the wheel 10 of a manual wheelchair 20 for a handicapped person is shown with reference to FIGS. 1 to 10, this device 1 possibly but not necessarily comprising additional functions as will be described below. FIGS. 1 to 7 only show the handrim 11 of the wheel 10, to make it easier to understand the figures.

FIG. 1 shows a first simplified embodiment of a device 1 for handling a wheel 10 of a manual wheelchair 20 according to the invention, positioned relative to the handrim 11 of the wheel 10.

The device 1 comprises a lever support 2 mounted in rotation around the X rotation axis of the wheel 10 coincident with the rotation axis of the handrim 11. The lever support 2 can thus be driven in rotation about its first direction of rotation F1, corresponding to the clockwise direction in FIG. 1, and according to its second direction of rotation F2 opposite the first direction of rotation F1.

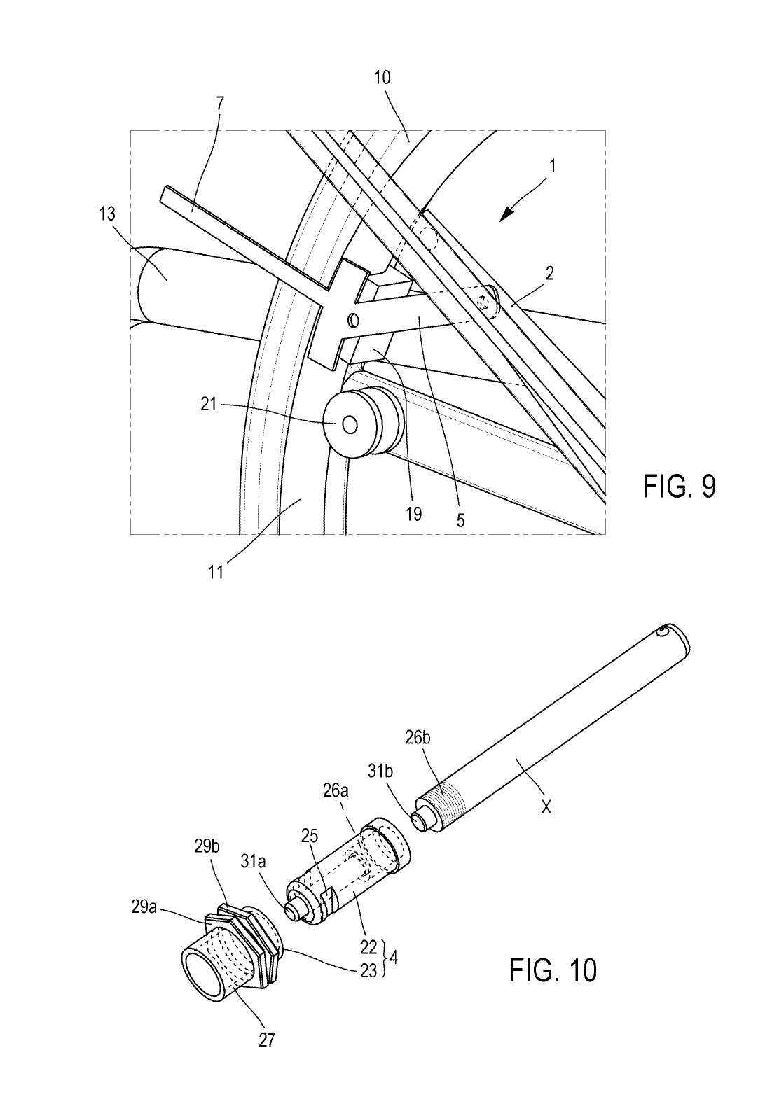

The lever support 2 is straight and its proximal end is fixed to the X rotation axis of the wheel 10 by an attachment means 4 that will be described in further detail below with reference to FIG. 9. The attachment of the lever support 2 and therefore the device 1 on the X rotation axis of the handrim 11 will be made very easily without requiring any major prior modification to the wheel 10.

The lever support 2 comprises a first part Pᵢ extending inwards relative to the handrim 11 and a second part Pₑ extending outwards relative to the handrim 11. On this second part Pₑ of the lever support 2, there is a gripping part 3 for the handicapped person, this gripping part 3 being coincident with the second part Pₑ in this example, although this is in no way limitative.

The handicapped person can use the gripping part 3 to handle the device 1 according to the invention to control displacements of the manual wheelchair 20. In particular, the gripping part 3 can be such that the handicapped person can push this gripping part 3 to drive the lever support 2 in rotation about its first direction of rotation F1 and can pull this gripping part 3 to drive the lever support 2 in rotation about its second direction of rotation F2.

Furthermore, the device 1 also comprises a pusher strut 5 fixed on the lever support 2 at its first part Pᵢ that extends inwards from the handrim 11 between the rotation axis X of the wheel 10 and the handrim 11.

The pusher strut 5 may for example be straight and it is fixed to the lever support 2 at its proximal end. Preferably, the point or zone 6 of attachment of the pusher strut 5 to the lever support 2 is in the upper third of the first part Pᵢ of the lever support 2 extending inwards from the handrim 11, in other words the third of the length of this first part Pᵢ located close to the handrim 11.

Furthermore, the pusher strut 5 is installed at the attachment point 6 in rotation about the lever support 2 about a Y rotation axis, the pusher strut 5 extending between the lever support 2 and a contact point C configured to come into contact C with the handrim 11 during rotation of the pusher strut 5 about its Y rotation axis. In other words, the position of the attachment point 6 of the pusher strut 5 on the lever support 2 and/or the length of the pusher strut 5 may be chosen such that the pusher strut 5 may have a contact point C with the handrim 11 during its rotation about the Y axis. In particular, the pusher strut may come into contact with the handrim 11 at its distal end. In particular, the pusher strut 5 comes into contact with the internal surface of the handrim 11, in other words the surface of the handrim 11 facing the rotation axis X of the wheel 10.

More precisely, and according to the invention, the attachment point 6 of the pusher strut 5 on the lever support 2 may be chosen on the first part Pᵢ of the lever support 2 extending inwards from the handrim 11 such that a) a force applied on the gripping part 3 by the handicapped person to cause rotation of the lever support 2 in its first direction of rotation F1 towards the pusher strut 5 creates contact C between the distal end of the pusher strut 5 and the handrim 11, which blocks rotation of the lever support 2 in the first direction of rotation F1 by binding, and thus moves the manual wheelchair 20, and b) such that a force applied to the gripping part 3 to cause rotation of the lever support 2 in its second direction of rotation F2 opposite the first direction of rotation F1, creates a lack of contact or a slipping contact between the handrim 11 and the pusher strut 5 which enables free rotation of the lever support 2 in the second direction of rotation F2 and thus puts the device 1 into its disengaged position.

Thus, any force and any increase in this force applied on the gripping part 3 by the handicapped person to cause rotation of the lever support 2 in its first direction of rotation F1 will cause pivoting and consequently the pusher strut 5 and the handrim 11 will be brought towards each other and adhesion at contact point C will increase such that slipping becomes impossible. A self-tightening or a binding phenomenon occurs between the pusher strut 5 and the handrim 11. Conversely, any force applied to the gripping part 3 by the handicapped person to cause rotation of the lever 2 in its second direction of rotation F2 opposite the first direction of rotation F1, will tend to move the pusher strut 5 away from the contact point C, in other words from the handrim 11, so as to disengage the device 1 and enable free rotation of the lever support 2.

In this way, assuming that the first direction of rotation F1 of the lever support 2 corresponds to the direction of forwards movement of the wheelchair 20 and the second direction of rotation F2 of the lever support 2 then corresponds to the backwards direction of the wheelchair 20, the device 1 can generate a stepped down forwards push due to the length of the lever support 2 being longer than the radius of the handrim 11. The lever support 2 may also comprise a gripping part 3, mounted telescopically relative to the remainder of the lever support 2 to increase the torque directly proportional to the total length of the lever support 2. Moreover, when pulling backwards on the gripping part 3, the result obtained is a free wheel effect to enable free rotation of the lever support 2 about the X rotation axis of the handrim 11, and then once again an automatic binding type blocking when another forwards push is applied on the gripping part 3.

Therefore with the device 1 according to the invention, the handicapped person can move his wheelchair 20 forwards with less physical effort, or can move backwards to back up or to turn around, can apply progressive forwards braking and can release the device 1 after disengagement to resume handling of the handrim 11 directly if necessary.

The device 1 can also function with and can be adapted onto a manual wheelchair 20 with defects and particularly geometric defects of its wheels 10. In particular, the device 1 may be adapted on a wheel 10 of the wheelchair 20 even if the handrim 11 of the wheel 10 has become oval, for example by the order of 1 cm, and/or is offset relative to the X rotation axis of the wheel 10, which for example can occur if the attachment cleats of the handrim 11 are twisted.

Therefore as mentioned above, the invention discloses a pressure principle for propulsion of the wheelchair 20, that is based directly on the handrim 11 in order to limit the weight and simplify the device 1.

FIG. 2 very diagrammatically shows operating principles of a handling device 1 according to the invention. It should be noted that these principles are in no way limitative of the examples described, but they may also be applied to any type of device according to the invention.

In this FIG. 2, the wheel 10 is represented by its handrim 11 only. Two examples of lever supports 2a and 2b are also shown, the lever support 2a carrying an example of a pusher strut 5a and the lever support 2b carrying two examples of pusher struts 5b and 5c. These examples will be described in detail later.

In order to understand the principle of the invention, a contact point C should be imagined between the handrim 11 and the pusher strut 5a, 5b or 5c of the device 1 as shown, and the situation is considered when a handicapped person applies a force on the gripping part 3 of the lever support 2a or 2b in a first direction of rotation F1 as previously disclosed with reference to FIG. 1, normally tending to displace the contact point C along the vector V as shown.

Then, the mechanical action R of the contact C between the pusher strut 5a, 5b or 5c and the handrim 11 has a direction inclined by an angle α relative to the axis normal to the handrim 11, its normal component N being oriented outwards from the handrim 11 and its tangential component T being located in the tangent plane coincident with the contact surfaces in the direction of the vector V.

The slip condition between the handrim number 11 and the pusher strut 5a, 5b or 5c, that advantageously allows the device 1 according to the invention to block by binding between the handrim number 11 and the pusher strut 5a, 5b or 5c, still effectively an adhesion condition, is given by Coulomb's law that specifies that the angle α must be strictly less than the angle of friction φ, that depends on the nature of the contact C, thus α<φ.

In particular, the angle φ may be given by the following relation:

μ=tan φ,

where μ is the adhesion coefficient between the pusher strut 5a, 5b or 5c and the handrim 11.

For example, in the case of a coefficient of adhesion μ equal to 1 (preferred case of the invention), the angle of friction φ is equal to 45°. Similarly, in the case of an angle of friction φ equal to 30° (for example the case of a pusher strut with a bicycle brake lining type material for contact with the handrim), the coefficient of adhesion μ may be as much as 0.58, knowing that tan (30°)=0.58, while engaging the device.

This non-adhesion condition between the pusher strut 5a, 5b or 5c and the handrim 11 can also be formulated as follows. The attachment zone 6 of the pusher strut 5a, 5b or 5c onto the lever support 2a or 2b must be located inside the friction cone C_{f} of the contact C, as shown. The vertex of this friction cone C_{f} is the contact C and the half angle at the vertex is the angle of friction φ. More particularly, since the attachment zone 6 is also located inside the handrim 11, it must be located in zone Z as shown by dotted lines that corresponds to the intersection between the friction cone C_{f} and the inside of the handrim 11.

Thus, when the attachment zone 6 is located inside the zone Z, a non-slip contact C can be maintained in the first direction of rotation F1 of the wheel 10 and the device 1 can be disengaged in the second opposite direction of rotation F2 of the wheel 10.

However, even though the attachment zone 6 is necessarily located in the above mentioned zone Z, there are constraints and/or advantages depending on the choice of the position of the hinge between the pusher strut and the lever support.

For example, the pusher strut 5a is fixed to the lever support 2a close to the X rotation axis of the handrim 11, such that there may be a tendency for the pusher strut to bend the lever support 2a at the attachment zone 6. The lever support 2a may thus have to be reinforced and be heavier. The pusher strut 5c is fixed to the lever support 2b close to the X rotation axis of the handrim 11, forming an angle α very much less than the angle φ such that there may be a risk of crushing the end of the pusher strut 5c in contact with the handrim 11, possibly fitted with a lining. On the other hand, the pusher strut 5b is fixed to a median part of the lever support 2b, sufficiently far from the X rotation axis of the handrim 11 and from the handrim 11, such that this configuration does not create high bending stresses on the lever support 2b and crushing of the end of the pusher strut 5b.

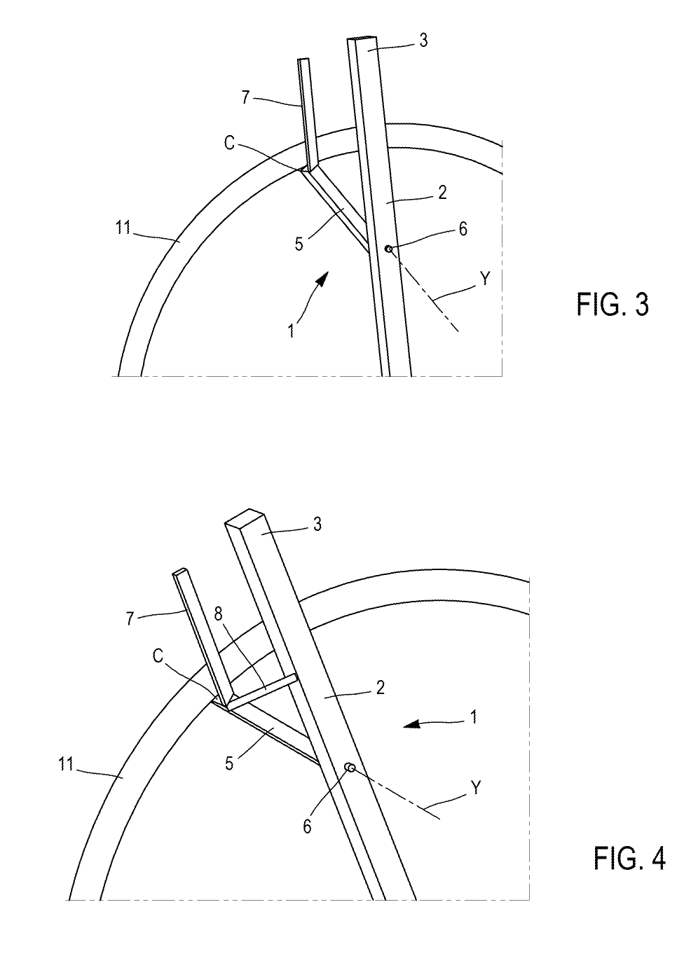

Furthermore as shown in FIG. 3, the handling device 1 according to the invention may also comprise an extension handle 7 to the pusher strut 5. The handle 7 mostly extends outwards from the handrim 11, so that the handicapped person can move the pusher strut 5 about its Y rotation axis.

In particular, the extension handle 7 of the pusher strut 5 corresponds to a brake handle 7 for the device 1 according to the invention. This brake handle 7 may thus be handled with the user's hand or fingers. The purpose is thus to be able to brake the manual wheelchair 20 by pivoting the pusher strut 5 towards the lever support 2 using the brake handle 7, so as to bring the contact point C of the pusher strut 5 more or less strongly flat in contact with the handrim 11. The braking force is then directly proportional to the force applied on the brake handle 7.

Moreover, the brake handle 7 may also be capable of moving the pusher strut 5 away from the lever support 2, so that there is no contact between the pusher strut 5 and the handrim 11 so that the lever support 2 can be pivoted forwards without self-tightening. Furthermore, a tension applied to the brake handle 7 and the lever support 2 when they are brought close to each other by squeezing until blocking is achieved by binding, can result in propulsion in the reverse direction in order to move the manual wheelchair 20 backwards.

Furthermore, as shown in FIG. 4, the handling device 1 may also comprise an elastic return device 8 fixed between the lever support 2 and the pusher strut 5.

The elastic return device 8 may also help to maintain an initial contact C between the pusher strut 5 and the handrim 11.

For example, the elastic return device 8 may be composed of a spring or an elastic.

The elastic return device 8 advantageously has a sufficient initial tension so that the pusher strut 5 and the lever support 2 may be moved towards each other in order to guarantee permanent contact between the pusher strut 5 and the handrim 11, even if the handrim becomes oval due to defects and/or shocks.

Furthermore, the maximum extension of the elastic return device 8 may be sufficient to make it possible to disengage the pusher strut 5 and possibly the brake lining support 19 of the pusher strut 5 as will be described later, from the handrim 11 when the handicapped person decides to disassemble the device 1.

FIG. 5 shows the possibility for the device 1 according to the invention to be provided with a locking device 9 in the position in which the pusher strut 5 is moved away from the handrim 11 so that there is no contact C between the pusher strut 5 and the handrim 11, the locking device 9 extending between the pusher strut 5 and the lever support 2, and being fixed to the pusher strut 5 or to the lever support 2.

The locking element 9 can assure permanent disengagement of the device 1 when it is correctly positioned between the pusher strut 5 and the lever support 2. The handicapped person may then decide to move forwards in the conventional manner using the handrim 11.

However, some elasticity of the locking element 9 makes it possible to keep the advantage of always being able to use the brake handle 7 to move the pusher strut 5 of the handrim 11 towards the lever support 2 each time that the brake handle 7 is squeezed. This means that the wheelchair 20 can be handled in a restricted space by using the brake handle 7 and the gripping part 3.

To achieve this, the thrust of the locking device 9 must also be able to compensate for the force from the elastic return device 8 in order to perform the permanent disengagement function, while making it possible for the locking device 9 to deform when the brake handle 7 is applied, until contact C is achieved on the handrim 11. Alternately, a single part may be used to act as the elastic return device 8 and the locking device 9.

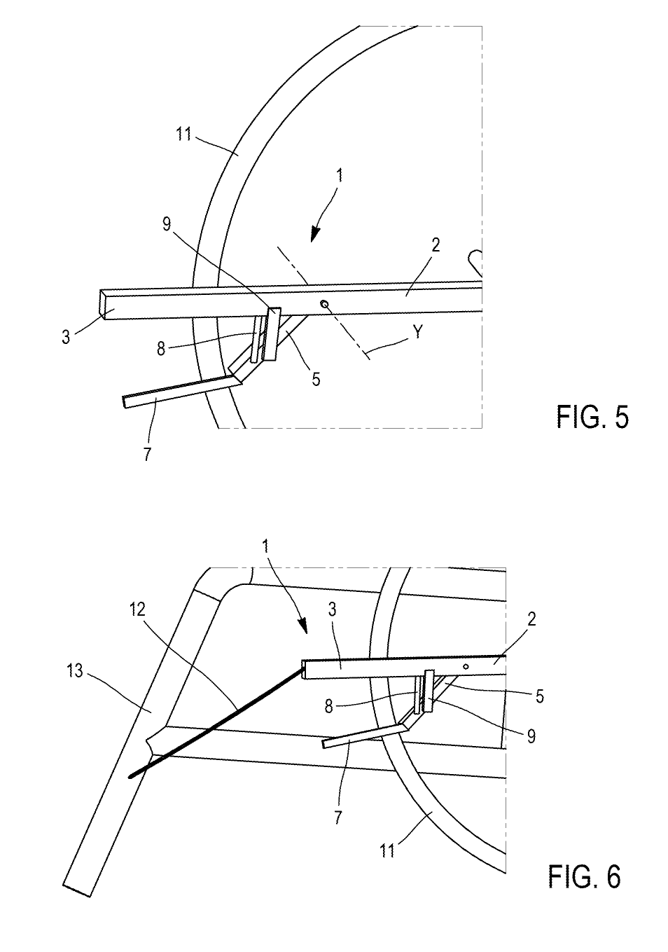

As shown in FIG. 6, the handling device 1 according to the invention may also comprise an attachment means 12 of the lever support 2 to the frame 13 of the manual wheelchair 20, extending between the lever support 2 and the frame 13 of the manual wheelchair 20.

Advantageously, the attachment means 12 can provide support to the lever support 2 if the device 1 should become disengaged and/or aid with pushing the lever support 2 after the handicapped person has pulled on the lever support 2.

The attachment means 12 may for example be in the form of a tensioner or a winding system. The extension capacity of this means may be 2 to 3 times between its initial position and the extended position (when the lever support 2 is behind).

The front part of the attachment means 12 may be fixed to the frame 13 of the wheelchair 20 after the lever support 2 has been put into place on the wheel 10. The back part of the attachment means 12 is fixed to the distal end of the lever support 2 or it may slide inside the lever support 2 for larger amplitude and flexibility as can be seen in FIG. 8.

If the attachment means 12 is very flexible, it can provide support for the lever support 2 only when it is not used, in other words when it is disengaged and not being used by the handicapped person.

If the attachment means 12 is more rigid or is held in position by another more rigid attachment means, for example with a pulling force of 5 to 10 kg when the lever support 2 is in the back position, the pulling force in the arms of the handicapped person can act as a potential energy reserve for the forward pushing force. This can therefore be very useful on difficult ground on which the wheelchair 20 tends to stop between two pushes (grass, gravel, slope, etc.).

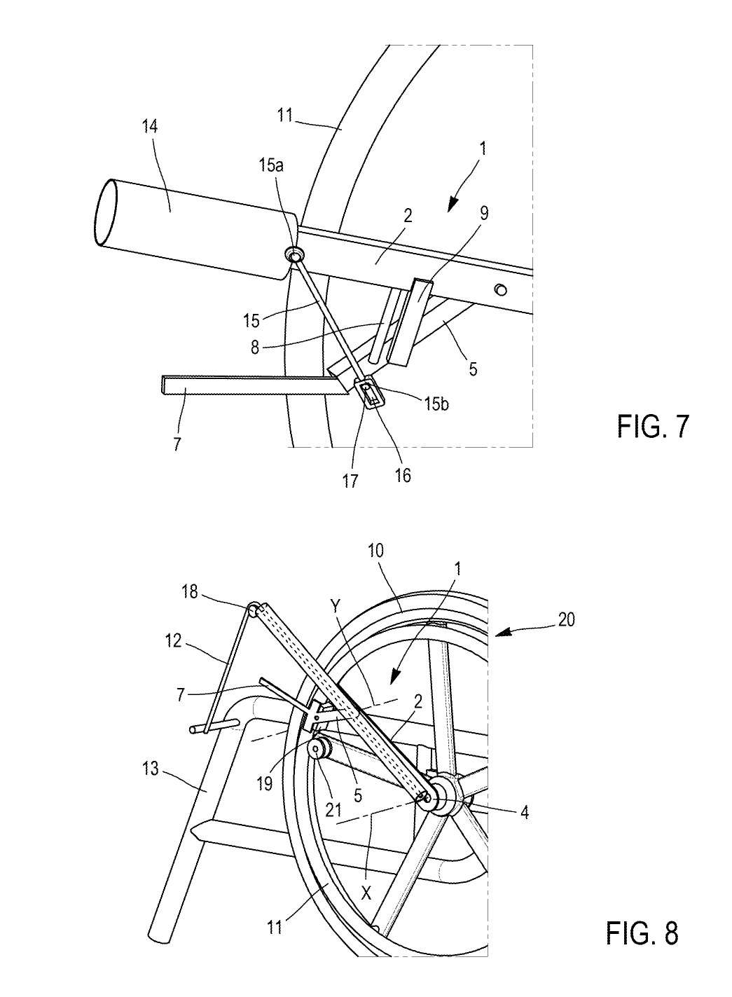

FIG. 7 shows the possibility that the handling device 1 according to the invention can be provided with a pivoting handle 14 at the gripping part 3 of the lever support 2. The pivoting handle 14 is installed free to rotate about the lever support 2. It may have an ergonomic shape to facilitate gripping by the handicapped person.

The device 1 according to the invention may also comprise a connecting rod support 15 fixed by a first end 15a to the pivoting handle 14, and by a second end 15b to the pusher strut 5. In this way, rotation of the pivoting handle 14 in a first direction of rotation causes a movement to bring the pusher strut 5 and the handrim 11 towards each other, and rotation of the pivoting handle 14 in a second direction of rotation moves the pusher strut 5 and the handrim 11 away from each other.

This solution can thus form an alternative actuation of braking, engagement and/or disengagement using the pivoting handle 14 instead of the brake handle 7.

Furthermore, as can be seen in FIG. 7, the connecting rod support 15 may comprise an opening 16 at its second end fixed to the pusher strut 5, in which an attachment pad 17 of the pusher strut 5 slides, as can be seen in FIG. 7. In this way, it may be possible to allow an unloaded travel of the pivoting handle 14 between the engaged and disengaged states of the device 1 so as to maintain self-tightening or the binding effect between the pusher strut 5 and the handrim 11 when the locking device 9 allows free rotation of the pusher strut 5.

Furthermore, as shown in FIG. 8 and FIG. 9 that is an enlarged view of FIG. 8, the pusher strut 5 may also comprise a brake lining support 19 that can come into contact with the handrim 11.

As can be seen particularly in FIG. 9, the brake lining support 19 may have a surrounding shape to match the profile of the handrim 11, for example by including a rim extending outwards from the handrim 11, or two rims on each side of the handrim 11.

FIG. 8 also shows the possibility of providing attachment means 12 in slipping form inside the lever support 2, for example being fixed to the X rotation axis of the wheel 10. The attachment means 12 can thus be fixed to the frame 13 of the wheelchair 20 and penetrate inside the lever support 2 by means of a pulley 18 placed at the distal end of the lever support 2.

This attachment means 12 can thus keep the lever support 2 horizontal when it is not being used, and if applicable perform a function to make use of the pulling force behind the lever support 2 in order to assure some of the forwards push, as described above.

Furthermore, FIGS. 8 and 9 also show the possibility for the device 1 according to the invention to be provided with an electrical assistance module 21 to help displacement for the handicapped person, in the form of a motor-driven rotating roller in contact with the handrim 11. Rotation of the roller causes rotation of the handrim 11. The force of the attachment means 12 determines the maximum force of the electrical assistance module 21.

FIG. 10 also shows the attachment principle of the handling device 1 according to the invention on the rotation axis X of the wheel 10.

In particular, the central attachment of the lever support 2 onto the fast disassembly axis X of the wheel 10 can for example be made by replacing the short nut usually located on the fast disassembly axis X of the wheel 10, by an elongated threaded part 22.

In particular, the threaded part 22 may comprise an internal thread 26a to enable permanent attachment of the threaded part 22 on an external thread 26b of the fast disassembly axis X of the wheel 10.

Furthermore, the threaded part 22 may comprise recesses 25, particularly two diametrically opposite recesses 25 to place a locking means on the wheel 10 when the device 1 according to the invention has been installed on the wheel 10. This locking means may for example be a pin or another more sophisticated locking system.

Furthermore, the threaded part 22 may comprise an extension 31a of the wheel release pusher 31b present on the fast disassembly axis X of the wheel 10, as shown.

Advantageously, the threaded part 22 is such that the device 1 can then be assembled on the wheel 10 of the manual wheelchair 20 and can be left permanently in place on the rotation axis X of the wheel 10 even if the device 1 is disassembled, without necessarily changing the global aesthetic appearance of the wheelchair 20.

Furthermore, the attachment means 4 may also comprise an attachment ring support 23 inside which the threaded part 22 can slide, such that the attachment ring support 23 is mounted free to rotate about the threaded part 22. The lever support 2 may then be fixed to the attachment ring support 23 so that it can be driven in rotation about the threaded part 22.

As shown, the attachment ring support 23 comprises an external thread 27 and two nuts 29a and 29b that will be located on each side of the lever support 2, so that the c/c distance of the lever support 2 can be adjusted as a function of the wheel type used. The offset between the hub of a wheel and the handrim of a manual wheelchair is not standardized on manual wheelchairs, such that the use of an attachment ring support 23 like that disclosed makes it possible to suit any type of manual wheelchair.

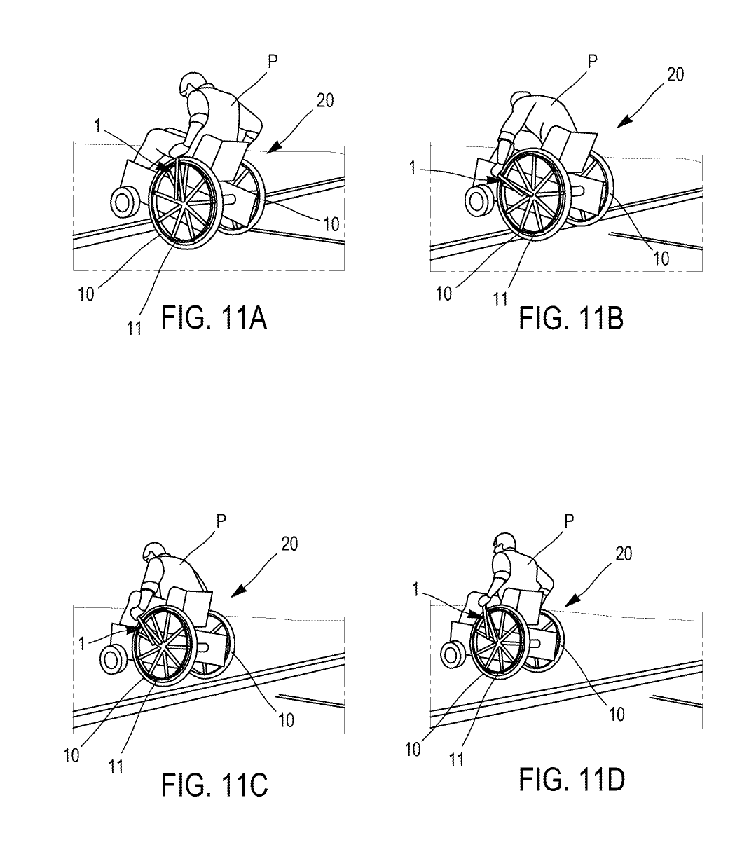

FIGS. 11A to 11D also show an example method of operability of a manual wheelchair 20 by a handicapped person P, the wheelchair 20 being provided with two handling devices 1 according to the invention (one device 1 for each wheel 10).

More particularly, FIGS. 11A to 11D show successive steps that the handicapped person P applies to go up a kerb.

Between the illustrations in FIGS. 11A and 11B, the handicapped person P applies a forwards push on the gripping parts 3 of the lever supports 2 of each handling device 11 along the first directions of rotation F1 of the lever supports 2, so as to move the manual wheelchair 20 forwards. As described previously, the pushing force applied on the gripping parts 3 of the lever supports 2 leads to a contact C between the pusher struts 5 of each handling device 1 and the handrims 11 of each wheel 10, causing a binding type blocking such that the forwards movement of the lever supports 2 also drives the handrims 11 and therefore the wheels 10 of the manual wheelchair 20.

In the view in FIG. 11C, the handicapped person P pulls on the gripping parts 3 of the lever supports 2 in their second direction of rotation F2 in order to disengage the handling device 1 so as to bring the lever supports 2 backwards.

Thus as shown in FIG. 11D, pushing once again on the gripping parts 3 of the lever supports 2 moves the manual wheelchair 20 forward once again.

Furthermore, during his or her displacements in the manual wheelchair 20, the handicapped person P may also choose to move the pusher struts 5 towards the lever supports 2, for example by using the brake handles 7 as described above, in order to obtain contact C between the pusher struts 5 and the lever supports 2 so as to brake the manual wheelchair 20.

The handicapped person P may also choose to move the pusher struts 5 towards the lever supports 2 to obtain contact C between them and to block by binding and pulling on the assemblies formed by the pusher struts 5 and the lever supports 2, for example by strongly squeezing the brake handles 7 and the gripping parts 3, so that it is possible to move the manual wheelchair 20 backwards.

Obviously, the invention is not limited to the example embodiment that has just been disclosed. Those skilled in the art can make various modifications to it.

The expression “comprising a” must be understood as being synonymous with “comprising at least one”, unless mentioned otherwise.

1. Device for handling a wheel of a manual wheelchair for a handicapped person, said wheel comprising a coaxial handrim to enable propulsion of the wheelchair, the device being capable of changing from a disengaged position in which the wheel rotates freely about its rotation axis, to an engaged position in which the wheel is driven in rotation about its rotation axis by the device, comprising:
a lever support configured to be installed in rotation about the rotation axis of the wheel, comprising a gripping part for the handicapped person extending outwards from the handrim when the device is placed on the wheel, said lever support comprising a first part extending inwards from the handrim, between the rotation axis of the wheel and said handrim when the device is in position on the wheel,
a lever support attachment means, capable of putting the lever support into position free to rotate about the rotation axis of the wheel,
a pusher strut fixed on the lever support at said first part, while being installed free to rotate relative to the lever support about a rotation axis, the pusher strut extending between the lever support and a contact point, the contact point being configured to come into contact with the handrim when the pusher strut rotates about the rotation axis, the lever support being capable of rotating about the rotation axis of the wheel in a first direction of rotation tending to move the lever support closer to the contact point of the pusher strut, and in a second direction of rotation, opposite the first direction of rotation,
the attachment zone of the pusher strut on the lever support being chosen on said first part of the lever support such that when the device is in position on the wheel, a force applied on the gripping part to make the lever support rotate about its first direction of rotation causes contact between the distal end of the pusher strut and the handrim, which blocks rotation of the lever support in the first direction of rotation by binding and puts the device in its engaged position, thus causing propulsion of the manual wheelchair, such that a force applied on the gripping part to cause rotation of the lever support in its second direction of rotation cancels the contact or creates slipping contact between the handrim and the pusher strut, which allows free rotation of the lever support in the second direction of rotation, and thus puts the device in its disengaged position.

2. Device according to claim 1, wherein a friction cone of the contact is defined between the pusher strut and the handrim, with the vertex at said contact and with half-angle at the vertex equal to the angle of friction defined by the relation μ=tan φ, where μ is the adhesion coefficient between the pusher strut and the handrim, and wherein the attachment zone of the pusher strut on the lever support is located inside the friction cone.

3. Device according to claim 1, wherein it comprises an extension handle of the pusher strut, extending mostly outwards from the handrim when the device is in position on the wheel, so that the handicapped person can turn the pusher strut about its axis of rotation.

4. Device according to claim 1, wherein it comprises an elastic return device fixed between the lever support and the pusher strut.

5. Device according to claim 1, wherein it comprises a locking device to lock the pusher strut in the position at a distance from the handrim so as to make sure that there is no contact between the pusher strut and the handrim, the locking device extending between the pusher strut and the lever support and being fixed to the pusher strut or to the lever support.

6. Device according to claim 1, wherein it comprises an attachment means for connecting the lever support to the frame of the manual wheelchair, extending between the lever support and the frame of the manual wheelchair, the attachment means enabling support of the lever support if the device is disengaged and/or aid in pushing the lever support after the handicapped person has pulled on the lever support.

7. Device according to claim 1, wherein the gripping part of the lever support comprises a pivoting handle, installed to rotate about the lever support, and a connection rod support fixed to the pivoting handle at a first of its ends and to the pusher strut at a second of its ends, opposite the first end, such that rotation of the pivoting handle in a first direction causes the handrim and the pusher strut to move towards each other, and rotation of the pivoting handle in a second direction opposite the first direction moves the pusher strut and the handrim away from each other.

8. Device according to claim 1, wherein the pusher strut comprises a brake lining support that can come into contact with the handrim.

9. Device according to claim 1, wherein the attachment means for connecting the lever support to the rotation axis of the wheel comprises a threaded part, capable of engaging on the rotation axis of the wheel when the device is assembled so that it can be permanently fixed to it, the lever support then being installed in rotation on the threaded part.

10. Device according to claim 1, wherein it comprises an electrical movement assistance module in the form of a motor-driven rotating roller that will be brought into contact with the handrim, rotation of the roller causing rotation of the handrim.

11. Wheel of a manual wheelchair for a handicapped person, fitted with a handling device according to claim 1.

12. Manual wheelchair for a handicapped person, comprising a handling device according to claim 1 or a wheel according to claim 11.

13. Operability method for a handling device according to claim 1, in which the handicapped person performs one or several of the following actions:
the handicapped person pushes the gripping part of the lever support in a first direction of rotation of the lever support, so as to make the manual wheelchair move forwards,
the handicapped person pulls the gripping part of the lever support in a second direction of rotation of the lever support in order to disengage the device so as to bring the lever support backwards before pushing the gripping part again so as to make the manual wheelchair move forwards once again,
the handicapped person moves the pusher strut towards the lever support to create contact between them, in order to apply a brake to the manual wheelchair,
the handicapped person moves the pusher strut towards the lever support to create contact between them by binding and pulls the assembly formed by the pusher strut and the lever support, in order to move the manual wheelchair backwards.
